(19) United States
(12) Patent Application Publication
(10) Pub. No.: US 2010/0122000 A1
(43) Pub. Date: May 13, 2010

(54) Method for Accessing a Data Transmission Bus, Corresponding Device and System

(76) Inventors: Ludovic Jeanne, Rennes (FR); Renaud Dore, Rennes (FR); Patrick Fontaine, Rennes (FR)

Correspondence Address: Robert D. Shedd, Patent Operations;THOMSON Licensing LLC, P.O. Box 5312, Princeton, NJ, 08543-5312, US

(21) Appl. No.: 12/086,457

(22) PCT Filed: Dec. 1, 2006
(86) PCT No.: PCT/EP2006/069181

§ 371 Date: Sep. 24, 2009

(30) Foreign Application Priority Data
Dec. 14, 2005 (FR) 0553872

(51) Int. Cl. G06F 13/00

(52) U.S. Cl. 710/110

(57) ABSTRACT

The invention relates to a bus, which is connectable to a primary master and to secondary masters, the bus being suitable for the transmission of data between the peripherals. In order to ensure a minimum rate and/or maximum latency between the secondary masters, when the primary master uses a small time fraction available on the bus, said primary master is provided with the highest priority and comprises means for wirelessly accessing to a medium. The inventive method for accessing to the bus consists in authorising the primary master to access to the bus upon the request thereof and in selecting the access to the bus for the secondary masters when the primary master peripheral does not request said access to the bus.

### 1. SCOPE OF THE INVENTION

The present invention relates to the electronic and computing domain and more particularly determinist high performance buses.

### 2. TECHNOLOGICAL BACKGROUND

According to the prior art, a Processor Local Bus (PLB) described with respect to FIG. 9 in the patent request U.S. Pat. No. 6,587,905 filed by the International Business Machines Corporation comprises several slaves and masters. Also, an access priority to the bus is defined for the masters. In the PLB, the master that has the lowest priority has access to the bus only when another master having access to the bus releases it.

This technique has the inconvenience of not guaranteeing the transmission bandwidth and the latency for each master. Also this bus is not adapted to low level communications (notably of physical layer type or PHY) or access to a communication channel known as Media Access Control (MAC). Nor is it adapted to partitioning between software and hardware resources.

### 3. SUMMARY OF THE INVENTION

The purpose of the invention is to overcome the disadvantages of the prior art.

More particularly, the purpose of the invention is to enable a determinist bus intended to be linked to a principle master peripheral device of higher priority and to secondary master peripheral devices and thus to guarantee a minimal bit rate and/or a maximum latency for a secondary master to the bus, when the principle master uses a low fraction of the available time on the bus.

For this purpose, the invention proposes a method of access to a bus intended to be linked to a principle master of higher priority and to secondary master peripheral devices, the bus being suitable for the transmission of data to and/or from the peripheral devices. According to the invention, the method comprises:
a step of bus access authorization to the principle master peripheral device when it requests access to the bus,
a step of bus access selection to one of the secondary master peripheral devices when the principal master peripheral device does not request access to the bus.

According to a preferred characteristic, the selection step comprises:
a step of assigning a revolving token to each of the secondary master peripheral devices,
a step of bus access authorization to the secondary master peripheral device that has the token, when it requests access to the bus,

Advantageously, the selection step comprises an arbitration step for access to the bus between the secondary master peripheral devices when the secondary peripheral device that has the token does not request access to the bus.

According to other characteristics, the arbitration step comprises:
a random selection step of a secondary peripheral device requesting access to the bus,
a selection step of the last secondary peripheral device having had access to the bus that requests access to the bus,
a selection step of the secondary peripheral device that requests access to the bus and did not have access to the bus for the longest time, or
a selection step of the secondary peripheral device that has been requesting access to the bus for the longest time.

According to a particular characteristic, the method comprises a selection step of the read or write type access.

According to another particular characteristic, the method comprises:
a step of bus read access authorization to the principle master peripheral device when it requests read access to the bus,
a step of bus read access selection to one of the secondary master peripheral devices when the principal master peripheral device does not request read access to the bus,
a step of bus write access authorization to the principle master peripheral device when it requests write access to the bus, and
a step of bus write access selection to one of the secondary master peripheral devices when the principal master peripheral device does not request write access to the bus.

According to an advantageous characteristic, the bus comprises at least one slave peripheral device, the method comprising a read and/or write access to the bus to an peripheral device authorized to transmit data to or from at least one of the slave peripheral devices.

The invention also concerns a access device to a bus intended to be linked to a principle master peripheral device of higher priority and to secondary master peripheral devices, the bus being suitable for the transmission of data between the peripheral devices, advantageously, the device comprises:
the means to authorize bus access to the principle master peripheral device when it requests access to the bus, and
the bus access selection means to one of the secondary master peripheral devices when the principal master peripheral device does not request access to the bus.

The invention also relates to a system that comprises:
a bus,
a principle master peripheral device of higher priority linked to the bus,
secondary master peripheral devices of the same priority linked to the bus, and
a bus access device such as that previously defined according to the invention,
   the bus being suitable for the transmission of data between the peripheral devices.

Advantageously, the system comprises at least one slave peripheral device linked to the bus, the slave peripheral device or devices not being able to request access to the bus.

According to a particular characteristic, the peripheral device or devices are memories.

Advantageously, the principle master peripheral device comprises a microprocessor.

According to a particular characteristic, the principle master peripheral device comprises an access means to a wireless medium.

According to a preferred characteristic, the system comprises a component that includes the bus and at least one of the secondary master peripheral devices and possibly, the principal master peripheral device.

### 4. LIST OF FIGURES

The invention will be better understood, and other specific features and advantages will emerge from reading the following description, the description making reference to the annexed drawings wherein:

FIG. 1 is a highly diagrammatical block diagram of a communication system according to a particular embodiment of the invention,

FIG. 2 diagrammatically shows the layer structure of the system of FIG. 1,

FIG. 3 details the system of the FIGS. 1 and 2 applied to a data exchange device with a access layer to the medium,

FIG. 4 presents a bus implemented in the system of FIG. 1,

FIGS. 5 and 6 illustrate timing diagrams during data exchanges on the bus of FIG. 4,

FIG. 7 shows an access algorithm to the bus of FIG. 4,

FIGS. 8 and 9 presents examples of access to the bus of FIG. 4,

FIGS. 10 and 11 show the arbiters suited to manage access to the bus of FIG. 4, and

FIG. 12 presents a master connected to the bus of FIG. 4.

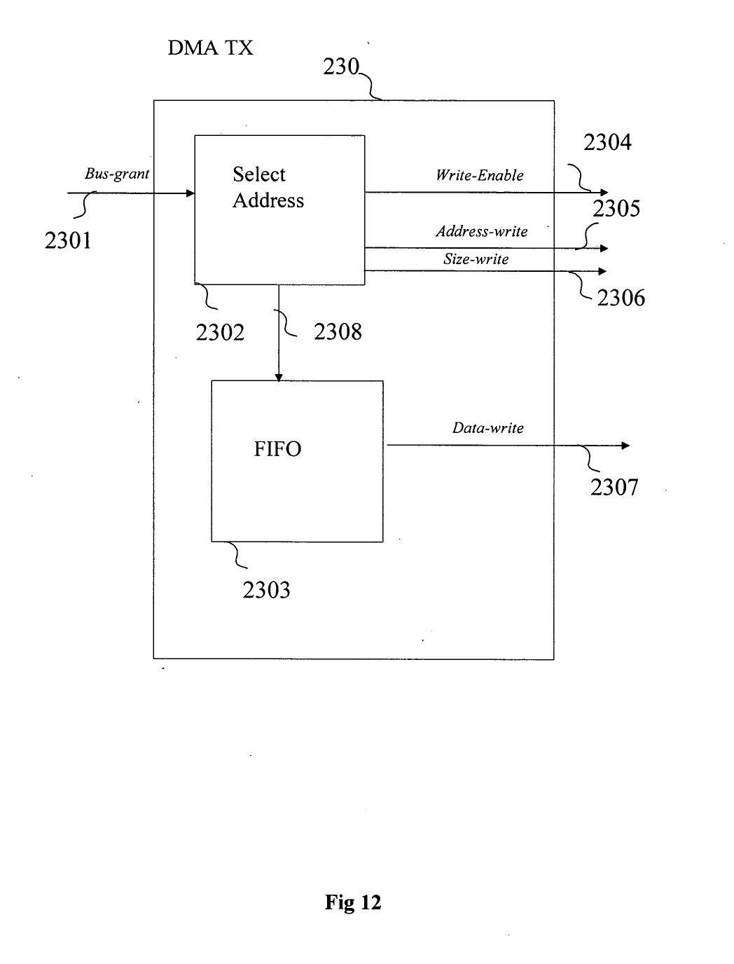

### 5. DETAILED DESCRIPTION OF THE INVENTION

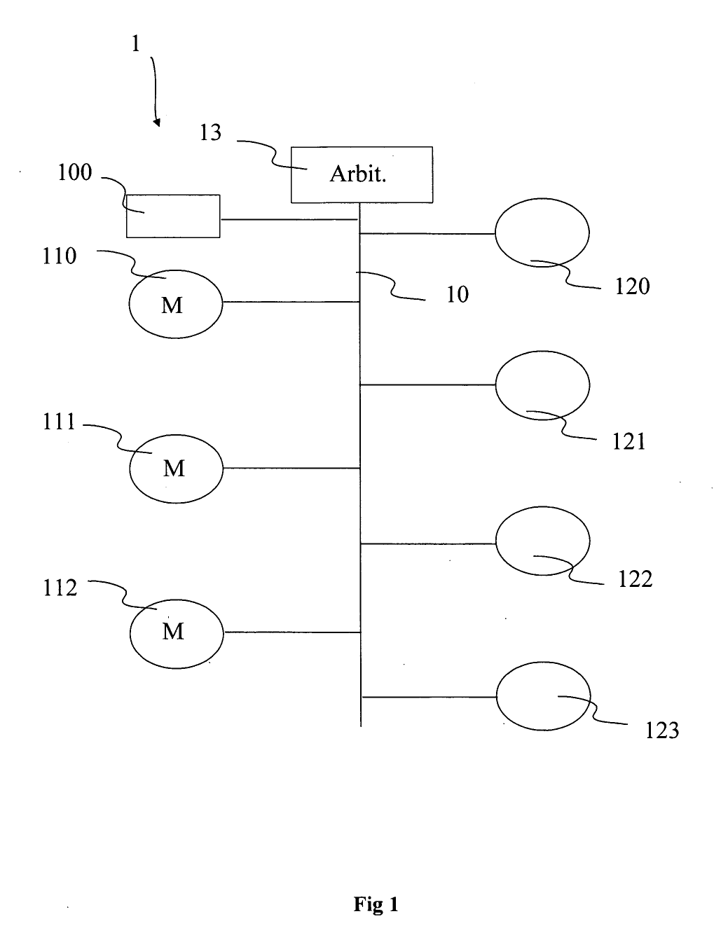

FIG. 1 diagrammatically presents a communication system 1 according to a particular embodiment of the invention.

The system 1 comprises:
a bus 10,
an arbiter 13 managing the accesses to the bus 10,
a principle master peripheral device 100 having the highest priority to access the bus 10,
secondary master peripheral devices 110 to 112 connected to the bus 10, and
slaves 120 to 123.

The masters 110 to 112 are suited to initiate data transfers in read and/or write mode on the bus. They have a lower priority than the principal master 100 to access the bus. Advantageously, the number of masters is unlimited and can take any value (for example 3, 10 or 100). The greater the number of masters, the more access authorizations the bus must be best managed, the time and the transmission bandwidth allocated to each of the masters being lower on average. The invention notably enables a fluidity in the accesses when the number of masters is high.

The slaves 120 to 123 receive and/or transmit data on the bus 10 and cannot initiate data transfers. In general, according to the invention, at least one slave is connected to the bus 10.

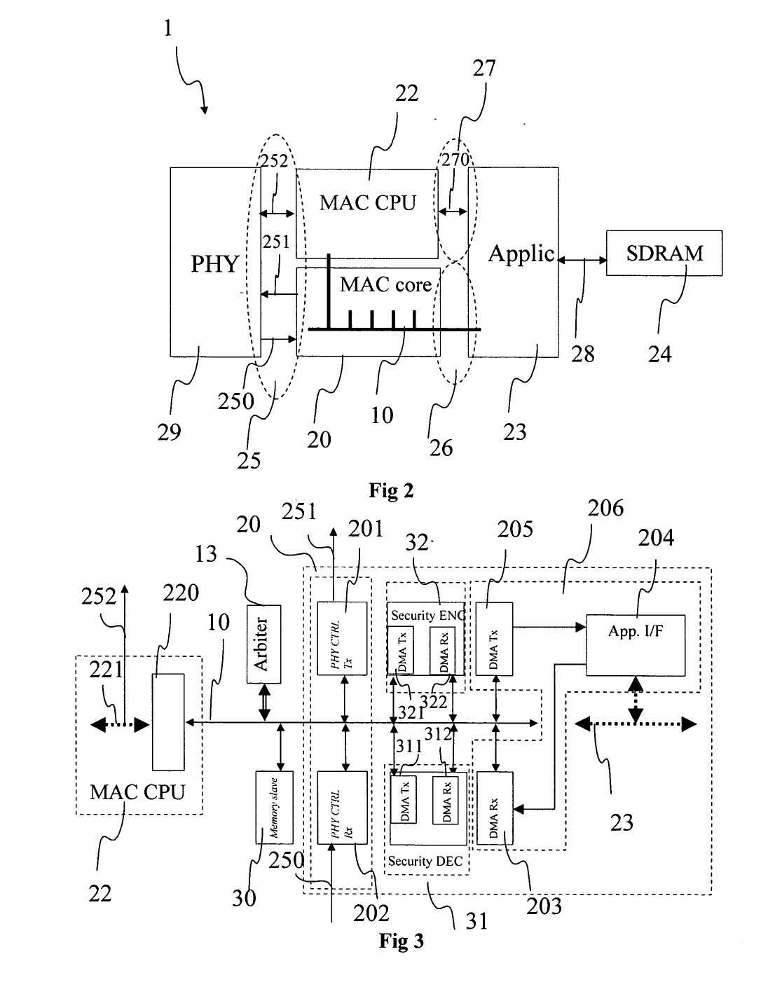

FIG. 2 diagrammatically shows the layer structure of the system 1. More precisely, the system 1 implements at least three layers comprising:
a physical layer or PHY,
a Media Access Control or MAC layer, and
an Application layer.

The medium is, for example a wireless communication layer (for example infra-red, radio (notably according to the standards WiFi, IEEE802.11, IEEE 802.16 and/or IEEE 802.15) or by powerline) or wireline. The bitrate of the transferred data can notably attain several hundreds of megabits.

FIG. 2 notably presents a division between hardware (or electronic components) and software elements known as hardware/software partitioning. The system 1 notably comprises:
A MAC core 20 comprising the bus 10, the MAC core being connected to a data transmission medium (physical layer) and/or an application layer,
A MAC CPU (Central Processing Unit) 22,
an application layer 23, and
a random access memory or SDRAM 24 that is connected to the layer 23 via a bi-directional link 28.

The physical layer 20 and the MAC layer are connected by a PHY-MAC interface 25 that comprises:
a bi-directional control link 252 between the layer 20 and the CPU 22, and
two mono-directional data transmission links 250 and 251 between the layer 20 and the MAC core 20.

The Application layer 23 is connected to the core 20 and the CPU 22 via the data transmission bus 10 (interface 26) and a bi-directional control link 270 respectively.

The bus 10 is connected to several masters of equal priority (not shown in FIG. 2), and at least one slave (not shown in FIG. 2) and to the CPU 22 that is the principle master peripheral device of the bus with a higher priority than the other masters, known as secondary master peripheral devices. Hence, the CPU 22 has priority for access to the bus (contrary to the prior art where the CPU has a lower priority than the masters for access to a bus).

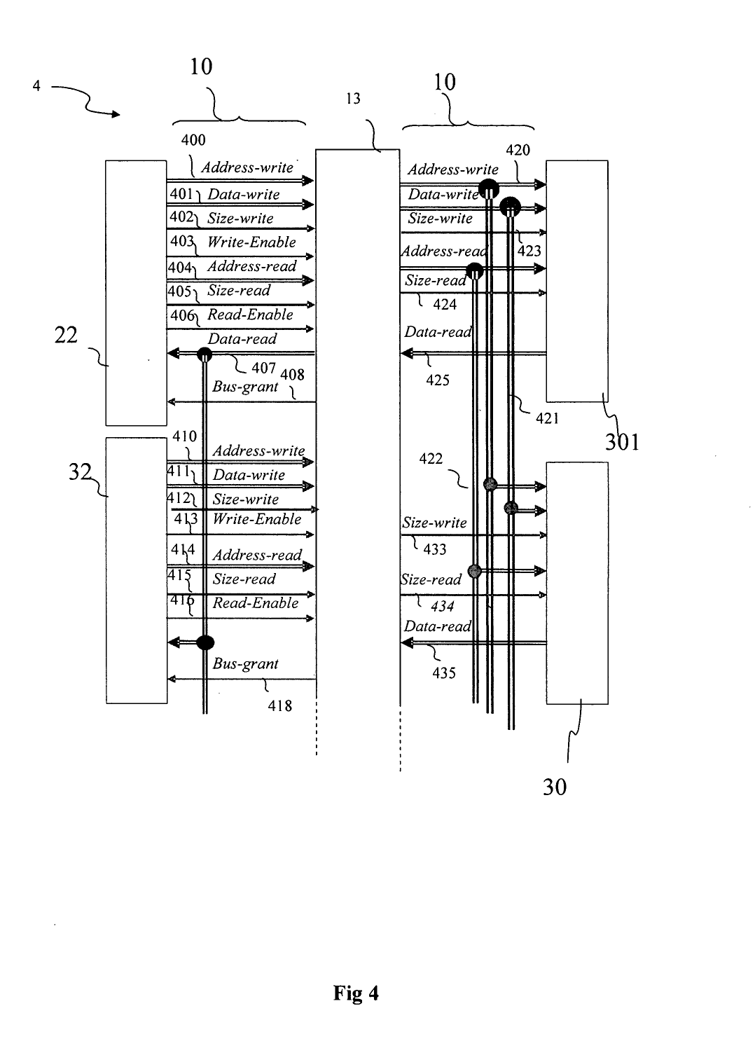

FIG. 3 details the system 1 applied to a data exchange device with MAC layer.

According to the system illustrated with regard to FIG. 3, the bus 10, whose accesses are controlled by the arbiter 13, connects:
an interface 220 connecting the bus 10 to a bus 221 internal to the unit 22, the interface 220 and the bus 221 belonging to the CPU 22,
a slave memory 30,
two control units of the physical layer respectively in transmission 201 (connected to the link 251) and in reception 202 (connected to the link 250),
two DMA units respectively of transmission 321 and of reception 322 in a security coder 32 (encrypting data, for example),
two DMA units respectively of transmission 311 and of reception 312 in a security coder 31 (deciphering the data, for example), and
two DMA units respectively of transmission 205 and of reception 203 both connected to a master interface 204 of a bus application 33, the units 203 and 205 as well as the master interface 204 belong to a module 206 of the interface with the application.

The bus 221 is a control bus of the other units of the system (for example for initialization). It is implemented for example, in the form of the APB part of an AMBA® bus. It is connected to link 252.

The units 201 to 205, the coder 32 and the decoder 31 are part of the MAC core 20.

The system for which an example is given as a means of illustration thus comprises:
a principle master peripheral device corresponding to the MAC CPU 22,
eight masters 201 to 205, 321, 322, 311 and 312 with the same priority (corresponding for example to masters 110 to 112 of FIG. 1) or secondary master peripheral devices, and
a slave 30.

Advantageously, the invention enables a partitioning between hardware and software resources, this partitioning being able to be made differently according to different hardware configurations.

In fact, according to a preferred embodiment, a sole component comprising the MAC core 20 is a programmable component (for example PGA “Programmable Gate Array”), a PLD “Programmable Logic Device”, a dedicated component or ASIC “Application Specific Integrated Circuit” or a microcontroller. Hence, the invention has the advantage of a very compact bus connecting several masters within one component. In fact, according to the prior art, to guarantee a level of efficiency of the bus within a component, the bus is divided into distinct complete sub-buses (with data, addresses and controls), each of the sub-buses being assigned to a master.

According to another variant, the MAC CPU 22 and the core MAC 20 are in a same component.

According to another variant, the component comprising the core MAC 20 and, if necessary, the MAC CPU 22, also comprise the memory 30.

According to other variants, the MAC CPU 22, the units 201 and 202, the module 206, the coder 32 and the decoder 31 are all or partly in separate components.

According to an embodiment not shown, the bus 10 is connected to two slave memories. Of course, the bus 10 can be connected to more slaves.

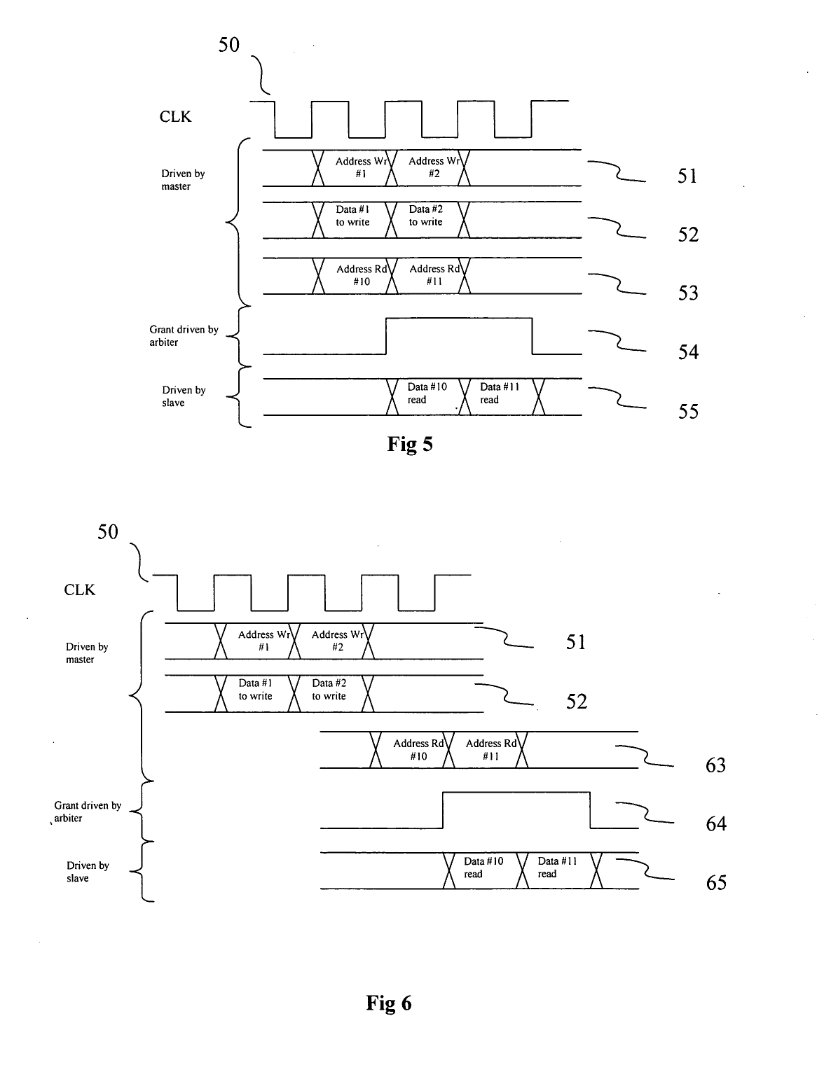

FIG. 4 shows the bus 10 with a number of masters (unit 22 and the coder 32) and slaves (memory 30 and another memory 301 enabling better vision of the connections, whether shared or not).

Unit 22 (respectively 32) is connected to the arbiter 13 in the master to arbiter direction via:
an address-write bus 400 (respectively 410) of 16 bits (or 20 bits according to a variant),
a data-write bus 401 (respectively 411) of 32 bits (or 16 bits or 64 bits according to the variants),
a size-write link 402 (respectively 412) on 2 bits,
a write-enable link 403 (respectively 413) on 1 bit,
an address-read bus 404 (respectively 414) of 16 bits (or 20 bits according to a variant),
a size-write link 405 (respectively 415) on 2 bits, and
a write-enable link 406 (respectively 416) on 1 bit.

Unit 22 (respectively 32) is connected to the arbiter 13 in the sense arbiter to the secondary master peripheral device via:
a bus-grant link 408 (respectively 418), and
a data-read bus 407 of 32 bits (or 16 bits or 64 bits according to the variants) shared by all the masters connected to the bus 13.

According to the embodiment described with regard to FIG. 4, a bus-grant link connects a secondary master peripheral device to the arbiter 13, in this case a secondary master peripheral device can access the write and the read buses simultaneously if the principle master peripheral device does not take control.

According to a variant of the invention, a secondary master peripheral device can also have write access (respectively read access) at the same time that the principle master peripheral device has read access (respectively write access), the access types by the secondary master peripheral device and the principal master peripheral device being different.

According to another variant, two bus-grant links, respectively in read mode 409 to 419 and in write mode 4010 to 4110, connect a secondary master periphery device to the arbiter 13. In this case, two secondary master peripheral devices can access the bus simultaneously, one in write mode and the other in read mode. This variant has the advantage of clarifying the accesses to the bus and enabling more rapid accesses and/or higher bitrates.

The slave 301 (respectively 30) is connected to the arbiter 13 in the arbiter to slave direction via:
an address-write bus 420 shared by all the slaves connected to bus 13 of 16 bits (or 20 bits depending on the variant),
a data-write bus 421 shared by all the slaves, of 32 bits (or 16 bits or 64 bits according to the variants),
a size-write link 423 (respectively 433) on 2 bits,
an address-read bus 422 shared by all the slaves of 16 bits (or 20 bits depending on a variant),
a size-read link 424 (respectively 434) on 2 bits.

The slaves 30 and 301 are connected to the arbiter 13 in the slave to arbiter direction, via a data-read bus 425 (respectively 435) of 32 bits (or 16 bits or 64 bits depending on the variants).

The data size signals 402, 412, 405, 415, 423, 433, 424 and 434 enable several data sizes carried on the bus 10 to be defined. Hence with a data size coded on 2 bits, three predefined data sizes are possible, for example: 8, 16 and 32 bits. According to a variant, the data bus comprises more than 32 bits (for example 64 bits or 128 bits), the predefined values are then chosen according to the size of the bus (for example, for a 64 bit bus, four data size values, namely 8, 16, 32 and 64 bits, can be predefined). Here, preferably, the predefined values follow a arithmetical progression of factor 2 (a predefined value being equal to twice the preceding value). According to other variants, the predefined values do not follow an arithmetical progression and can be any value less than or equal to the size of the data bus.

According to an embodiment variant, the data is coded according to a fixed size and the data size signals (and the corresponding links) are omitted.

The arbiter 13 is, for example, implemented in the form of an electronic circuit, a programmable circuit, ASIC or micro-controller or microprocessor. The bus cabling enables identification of the highest priority master CPU (or principle master peripheral device), the masters of equal priority (or secondary master peripheral devices) and the slaves.

The bus 10 comprises other signals such as clock (CLK) and reset signals that are linked to all the peripheral devices connected to the bus and the arbiter 13. The clock signal is not shown on the figures in order to ensure readability.

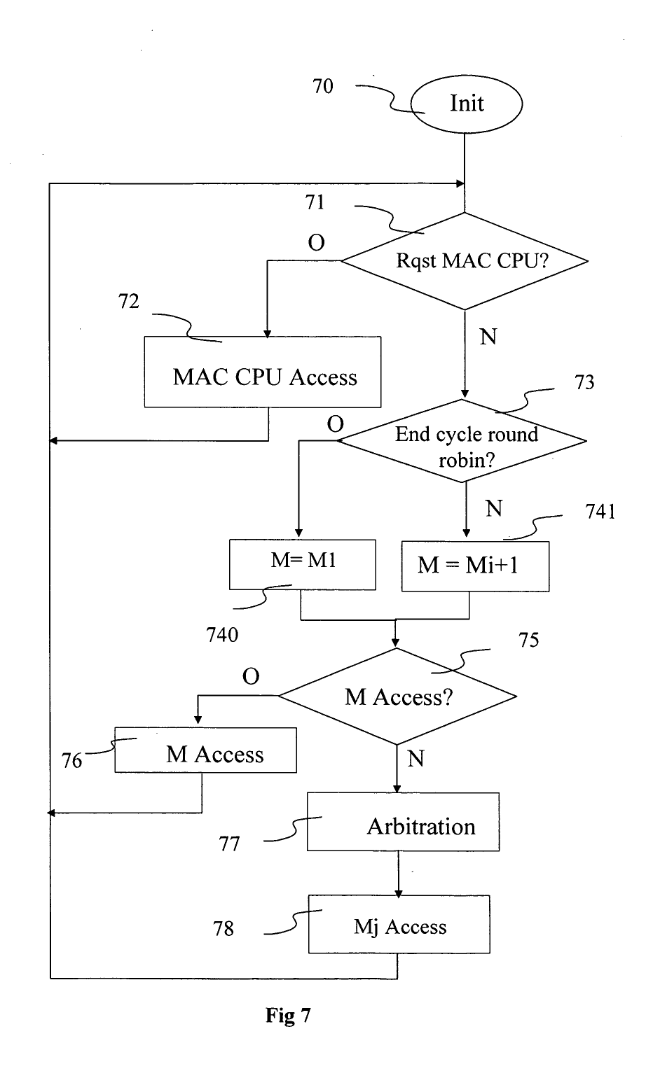

FIG. 5 shows a timing diagram during data exchange on the bus 10 according to an embodiment where the read and write data operations can be simultaneous. Simultaneous read and write operations are well adapted to masters that enable these operations (for example, masters that have Direct Access Memory (DMA) in matched transmission and reception).

All signals are synchronized from a clock signal 50.

On a first clock rising edge, the write address signals 51 are activated at the same time as the data 52 for the master that received access authorization via the corresponding “bus grant” signal. These signals remain valid during a clock cycle.

Simultaneously, a master requests (“read-enable” signal 53) and obtains the access to the bus on a rising edge of the clock signal 50. The corresponding data (for example supplied by the slave) is presented at the next clock cycle (signal 55), a read-access (signal 54) being granted by the arbiter 13.

According to a variant embodiment of the invention, the bus 10 is separated into two distinct buses that function respectively in read and in write mode.

The invention enables high bit-rates on the physical layer. As an illustration, for a 40 MHz bus clock (for implementation in FPGA form), the bitrates on the physical layer are greater than 100 Mbit/s with a data bus of 32 bits. The read and write instantaneous bit-rate can reach 2.56 Gbit/s. With an ASIC implementation, the clock bitrate can be determined at greatly superior speeds (for example 80 MHz). The bit-rates are then increased proportionally. For a secondary master peripheral device, the maximum latency to access the bus (excluding access to the principle master) is equal to the product of the number of secondary master peripheral devices multiplied by the number of clock pulses per cycle.

FIG. 6 shows a timing diagram during data exchanges on the bus 10 according to a variant embodiment, the read and write operations being performed sequentially and not simultaneously.

The elements 51 and 52 are common to FIGS. 5 and 6 and have the same references. They are therefore not further described.

The read-data signal to a specific address 63 is implemented only when the bus is free in read mode.

According to the embodiment corresponding to the timing diagram of FIG. 6, the bus arbiter manages read-access and write-access in a decorrelated manner. The bus is accessed alternately between read and write. According to a variant embodiment of the invention, the read-accesses and write-accesses are not alternating and the priority between read and write is defined in any manner, for example, random or on the contrary according to a predefined rule, notably according to arrival order and/or according to the priority of the secondary master peripheral device requesting a bus access.

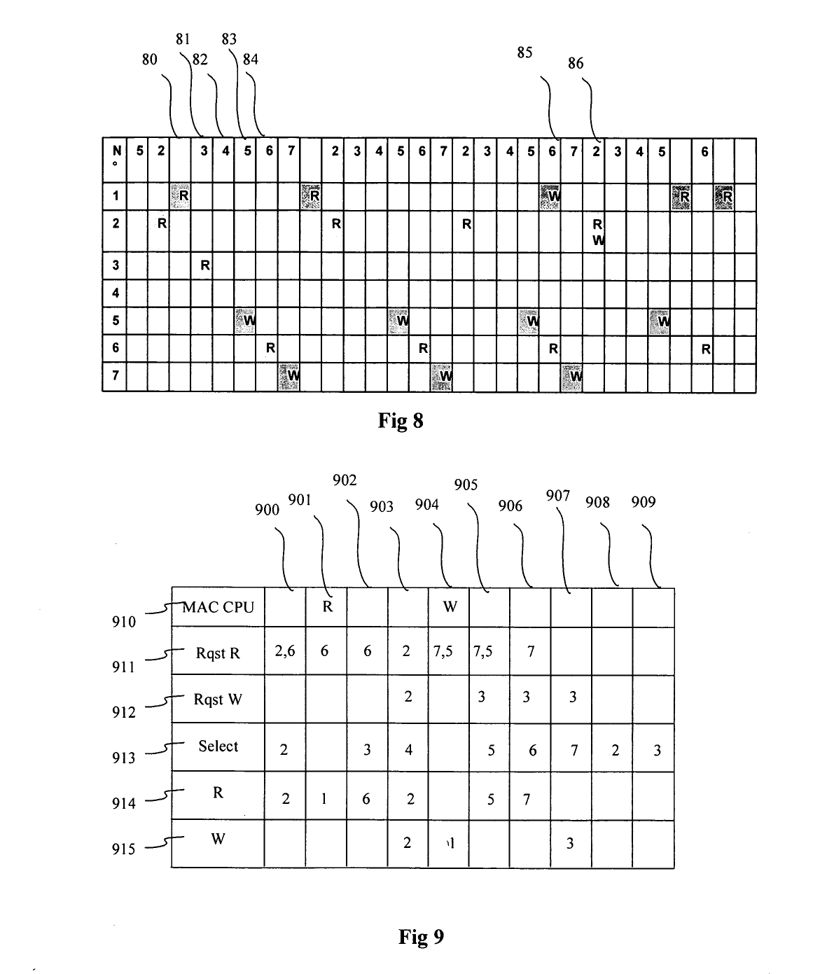

FIG. 7 shows a bus access algorithm 10 (that can for example be implemented in VHDL when the arbiter is implemented in a programmable component).

During an initialization step 70 corresponding to activation of a reset signal, the arbiter 13 is initialized, the output signals are deactivated and the internal registers (particularly a current master register) are also initialized. Then, data read/write cycles are implemented. These cycles are synchronized on a clock signal, an elementary loop in the flow chart corresponding to a clock cycle.

The elementary loop begins with a test 71, during which the arbiter 13 verifies whether the central processing unit 22 wants an access (write-enable or read-enable signal activated). In the affirmative case, access is given to the central processing unit 22 during a step 72 by activation of the signal 408.

In the negative case, the central processing unit 22 does not request access, and access can then be given to another master. The arbiter 13 manages cycles for each of the secondary master peripheral devices of the same priority having fair access to the bus 10. Also, the arbiter 13 defines an ordered sequence among the secondary master peripheral devices. Hence, during a step 73, it verifies if it has reached the end of the sequence. If the answer is yes, then during a step 740, it reinitializes the sequence and considers the first secondary master peripheral device as the current master. Otherwise, during a step 741, it moves on to the next secondary master peripheral device, which becomes the current master.

According to a first embodiment of the invention, the ordered sequence is fixed when defined for the first time in a random manner or according to the types of masters.

According to a variant, the ordered sequence is randomly modified during the step 740. Hence, a mixture of masters can be obtained for greater fairness. According to another variant, the ordered sequence is modified during the step 740 according to exterior events (for example, according to a command transmitted by the principal master or a secondary master).

Then, during a step 75, the arbiter 13 checks whether the current master M has requested an access to the bus. In the affirmative case, it gives bus access to the current master in step 76.

In the negative case, it determines a master Mj from among the masters that have requested a bus access during an arbitration step 77 and gives bus access to it during a step 78. The arbitration step 77 notably enables the transmission bit-rate to be increased when the current master does not request a bus access.

Several arbitration strategies can be considered for step 77, particularly:
a strategy of random attribution,
an access given to the most recent master having had access to the bus,
an access according to the master priority number (the masters being connected to the bus in order of their priority, for example, in a purely electronic implementation, with the cable pins assigned according to the respective priority of the masters),
an access according to a logical order depending on previous accesses (for example, access to a master that generally requests access following the access of another given master) the logical order being tabulated for example,
an access according to the requested access type (read or write), priority being given to one of the two types of access, and/or
an access to the first peripheral device that requested access to the bus.

The algorithm preferentially corresponds to a hardware implementation using logical ports. The write access signals can be summarized in the following manner:

bus-grant(Mp)=write-enable(Mp)

bus-grant(M)=write-enable(Mp))·write-enable(M);

bus-grant(Mj)=write-enable(Mp)·write-enable(M)·write-enable(Mj)

where:
Mp represents the principle master (here unit 22), M the current master and Mj the master determined by an arbitration step, and
where bus-grant(X) represents the bus access authorization signal for a master X, write-enable(X), the bus access request signal from a master X and write-enable(X) the opposite signal (obtained using an inverter gate).

The operator “.” represents a logical multiplication and can be implemented using an AND port.

Step 73 can be implemented using a computer.

The above operations are synchronized on the clock.

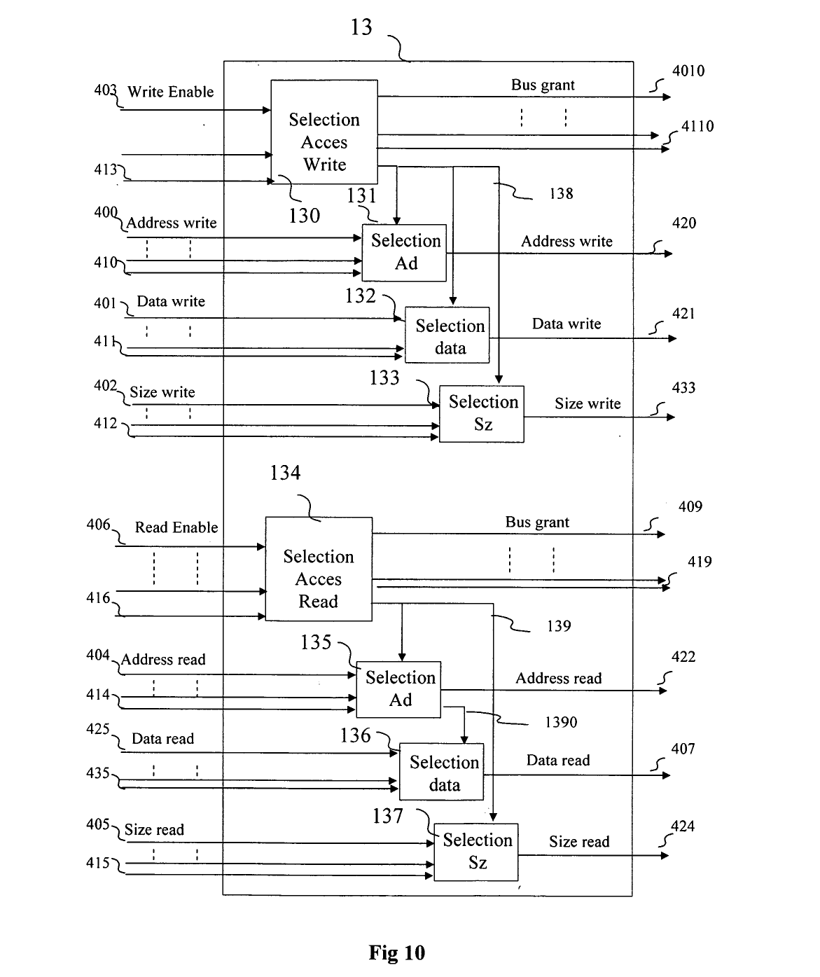

FIGS. 8 and 9 present the successive accesses to bus 10.

More precisely, FIG. 8 corresponds to a simplified implementation that not providing for bus access when neither the MAC CPU nor the current master do not request the bus (there are no steps 77 and 78 in this case). FIG. 9 presents the successive accesses to the bus 10 according to the algorithm presented in respect of FIG. 7 implementing the arbitration phase when neither the MAC CPU nor the current master request the bus.

According to FIG. 8, it is assumed that the ordered sequence is (2, 3, 4, 5, 6, 7).

The elements referred to in the first line of the table of figure represent the current master as a function of time: masters of the same priority are numbered with a parameter N taking values 2 to 7. The first column represents the masters (the MAC CPU has an N parameter equal to 1).

During the first cycle, the master with N having a value of 5 is the current master and does not request access to the bus.

During a second cycle 80, the secondary master peripheral device with N having a value of 2 is the current master, it requests and obtains read-access to the bus (symbolized by the letter R).

During a third cycle 81, the unit 22 requests and obtains read access, prohibiting read access for the secondary master peripheral device with N having a value of 3.

During the following cycles 82, 83, 84 etc. the arbiter gives priority to unit 22 or, if unit 22 does not request bus access, to the current master (N taking the successive values of the ordered sequence (2, 3, 4, 5, 6, 7)) in write-access (symbolized by the letter W) or in read-access.

It is noted that there can be write-access and read-access simultaneously by the current master and/or unit 22 (some but not necessarily all masters can support read-access and write access). This is the case, for example, during a cycle 85, where the unit 22 has bus access and a current master (N having a value of 6) has read access (corresponding to the variant in which such an access is possible). This is also the case, during a cycle 86, where the secondary master peripheral device with N having a value of 2, accesses the bus in both read and write modes.

According to FIG. 9, it is assumed that the ordered sequence is (2, 3, 4, 5, 6, 7).

The table of FIG. 9 comprises the following lines successively:
the indication that the principle master peripheral device requests the bus with the type of access required write W or read R,
the value of the N parameter corresponding to the secondary master peripheral devices requesting read-access to the bus,
the value of the N parameter corresponding to the secondary master peripheral devices requesting write-access to the bus,
the secondary master peripheral device selected by the arbiter during the selection step, the principle master peripheral device not requesting access to the bus,
the master peripheral device having read-access to the bus, and
the master peripheral device having write-access to the bus.

In the example given here, it is assumed that if the principle master peripheral device requests control, a secondary master peripheral device cannot have access to the bus.

During a first cycle 900, two secondary master peripheral devices corresponding to N having values of 2 and 6 respectively, request read-access. The arbiter having selected the master with N having a value of 2 therefore gives it access to the bus.

During the second cycle 901, the MAC CPU requests control in read-access and so obtains it.

During a third cycle 902, the master selected with N having a value of 3 does not request control, the master with N having a value of 6 being the only master to request access to the bus, during the arbitration step, it obtains read-access to the bus.

During a fourth cycle 903, the master with N having a value of 2 requests access to the bus in both read and write mode and obtains this access, the master selected with N having a value of 4, not requesting access to the bus.

During a fifth cycle 904, the principle master and the secondary master peripheral devices with N having values of 7 and 5 request access to the bus. The principle master thus obtains bus access.

During a sixth cycle 905, the secondary master peripheral device with N having a value of 3 also requests access to the bus. The arbiter selects the master with N having a value of 5. The arbiter then obtains access to the bus.

During a seventh cycle 906, the master selected with N having a value of 6 not requesting access to the bus, the arbiter, during an arbitration step between the masters with N having values of 3 to 7 gives control to the peripheral device whose N value is 7.

Then during a cycle 907, the master with N having a value of 3 has access to the bus.

Then, during the following two steps 908 and 909, no master requests access to the bus, the bus remains free.

Hence, the arbitration phase enables time slots to be used when the principle master and the secondary master do not request access to the bus.

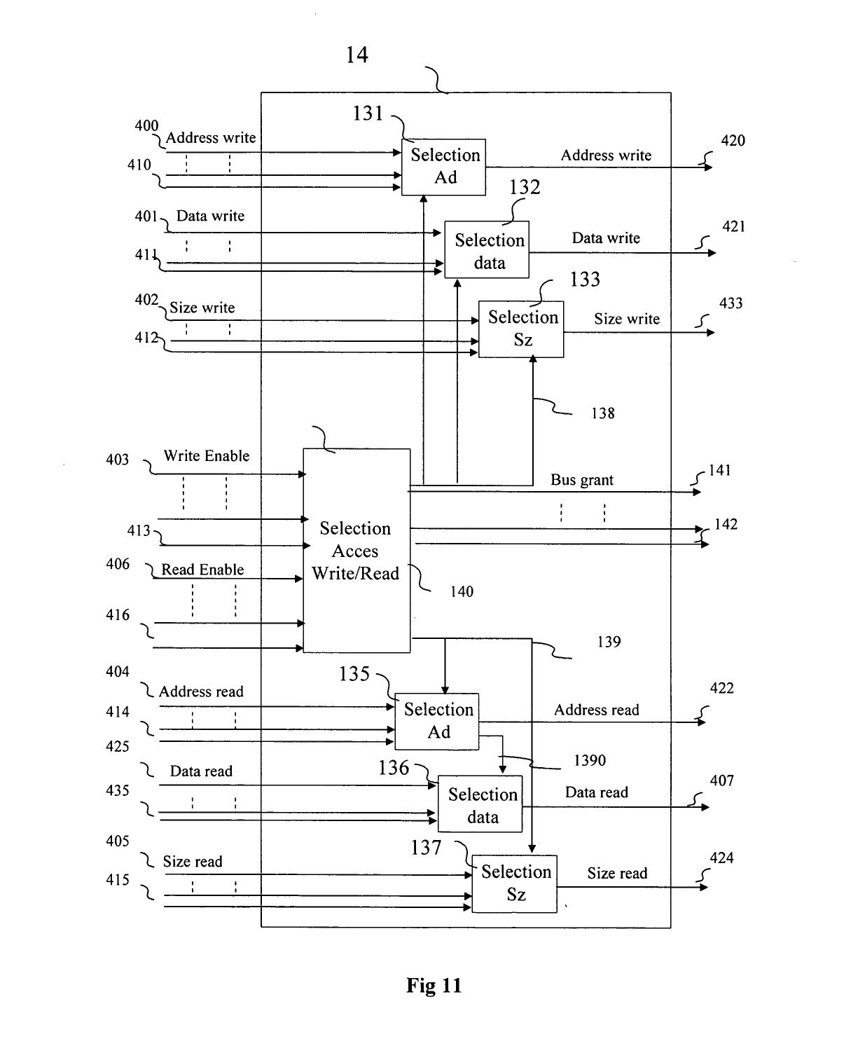

FIG. 10 illustrates the structure of the arbiter 13, the read-accesses and the write-accesses to the bus being decorrelated.

The arbiter 13 comprises:
a write-access selection module 131,
an address-write multiplexer 131,
a data-write multiplexer 132,
a size-write multiplexer 133,
a read-access selection module 134,
an address-read multiplexer 135,
a data-read multiplexer 136,
a size-read multiplexer 137,

The access selection module 130 (respectively 134) receives the write-enable request entry signals 403, 413 (respectively 406, 416) from the various masters. It implements the algorithm of FIG. 7 to give access to one of the masters and activates, if necessary:
one of the bus-grant signals 4010 to 4110 (respectively 409 to 419) associated with the master having received the access authorization, and
the command signal 138, piloting the multiplexers 131 to 133 (respectively 135 to 137) depending on the master that has received access authorization.

The address multiplexers 131 (respectively 135) receive signal addresses 400, 410 (respectively 404, 414) from the various masters. It presents in output the address signals 420 (respectively 422) according to the command signal 138 (respectively 139) that it receives.

The address multiplexer 132 also generates a command signal 1390 according to the peripheral device (slave) comprising the selected address.

The data multiplexer 132 (respectively 136) receives the data signals 401, 411 (respectively 425, 435) from the various slaves. It presents the data signals 421 (data-write) (respectively 407 (data-read)) at the output according to the command signal 138 (respectively 1390) that it receives.

According to a variant of the invention, the bus accepts only a suitable slave to supply the read data. In this case, the module 136 and the signal 1390 (and the means of generating it) are omitted.

The size multiplexers 133 (respectively 137) receive the size signals 402, 412 (respectively 404, 414) from the various masters. It presents the size signals 433 (respectively c424) at the output according to the command signal 138 (respectively 139) that it receives.

FIG. 11 illustrates an arbiter structure 14 according to a variant embodiment of the invention, corresponding to an implementation where the read-access and/or write access are authorized for the principle master peripheral device and/or a single secondary master peripheral device during a given cycle.

The arbiter 14 is similar to the arbiter except for the modules 131 and 134 that are replaced by a single address selection module 140, the bus being unable to accept a write and read operation simultaneously. Each master receives a read/write access authorization signal 141, 142 that is dedicated to it. The other elements are similar, having the same references and are not further described.

The module 140 receives the bus access authorization request signals for write operations 403, 413 and read operations 406, 416 from the various masters connected to the bus. It generates:
the bus access authorization signals 141, 142 according to the master determined by the implementation of the algorithm of FIG. 7, and
the command signals 138 and 139 according to the master thus determined and the access type or types (write or read) requested by the master thus determined.

Naturally, the invention is not limited to the embodiments previously described.

In particular, the invention is compatible with numbers and functions of masters and/or slaves different to those previously described.

Also, the number of data bits, addresses, the size of data transmitted in parallel on the bus is not fixed and can take values other than those indicated previously according to different embodiments of the invention.

The signals indicating the size of data transmitted simultaneously are omitted when the size of the transmitted data is fixed.

Moreover, other signals than those described previously can be present on the bus, according to and especially:
a signal of dynamic change in the order of the secondary master peripheral devices in the arbitration steps,
an activation signal or non-activation signal of the implementation of an arbitration if the secondary master peripheral device selected by the arbiter to access the bus, does not request access,
a signal of dynamic change in the selection order of access to the bus of the secondary master peripheral devices when the principal master peripheral device does not request access to the bus.

Notably these signals can be implemented by a CPU (Central Processing Unit).

The invention enables a great freedom of use, facilitates a core reconfiguration for an adaptation for a particular application and/or a specific physical layer and is well adapted to a modular design. Hence, the invention is also compatible with a totally electronic implementation (in the form of components) or, on the contrary partly software (for example in the case of “radio software” that can be easily reconfigured according to the context). Moreover, the invention is applicable to many domains, and notably in the wired or wireless communications domain (particularly an interface with a physical layer of type IEEE 802.16, IEEE802.15.3 (UWB)).

1. Method of access to a data bus, intended for connection to a principle master peripheral device and to secondary master peripheral devices, the bus being suitable for data transmission to and/or from said peripheral devices and conveying the frames at MAC layer level, wherein the principle master peripheral device has the highest bus access priority and comprises access means to a wireless medium,
and wherein said method comprises:
a step of bus access authorization to the principle master peripheral device when it requests access to the bus, and
a stage of bus access selection to one of the secondary master peripheral devices when the principal master peripheral device does not request access to the bus.

2. Method according to claim 1, wherein the selection step comprises:
a step of assigning a revolving token to each of said secondary master peripheral devices, and
a step of bus access authorization to the secondary master peripheral device that has the token, when it requests access to the.

3. Method according to claim 2, wherein the selection step comprises an arbitration step for access to the bus between the secondary master peripheral devices when the secondary peripheral device that has the token does not request access to the bus.

4. Method according to claim 3, wherein the arbitration step comprises a random selection step of a secondary peripheral device requesting access to the bus.

5. Method according to claim 3, wherein the arbitration step comprises a selection step of the last secondary peripheral device having had access to the bus that requests access to the bus.

6. Method according to claim 3, wherein the arbitration step comprises a selection step of the secondary peripheral device that requests bus access and that has not had access to the bus for the longest period.

7. Method according to claim 3, wherein the arbitration step comprises a selection step of the secondary peripheral device that has requested access to the bus for the longest period.

8. Method according to claim 1, wherein it comprises a selection step of the write or read access type.

9. Method according to claim 1, wherein it comprises
a step of bus read access authorization to the principle master peripheral device when it requests read access to the bus,
a step of bus read access selection to one of the secondary master peripheral devices when the principal master peripheral device does not request read access to the bus,
a step of bus write access authorization to the principle master peripheral device when it requests write access to the bus, and
a step of bus write access selection to one of the secondary master peripheral devices when the principal master peripheral device does not request write access to the bus.

10. Method according to claim 1, wherein said bus comprises at least one slave peripheral device, the method comprising a read and/or write access to the bus to a peripheral device authorized to transmit data to or from one of said slave peripheral devices.

11. Device of access to a data bus, intended for connection to a principle master peripheral device and to secondary master peripheral devices, the bus being suitable for data transmission to and/or from said peripheral devices and conveying the frames at MAC layer level, wherein, said principle master peripheral device has the highest bus access priority and comprises access means to a wireless medium,
and wherein said device comprises:
the means to authorize bus access to the principle master peripheral device when it requests access to the bus, and
the bus access selection means to one of the secondary master peripheral devices when the principal master peripheral device does not request access to the bus.

12. System comprising
a data bus,
a principle master peripheral device of higher priority linked to said bus and comprising access means to a wireless medium,
secondary master peripheral devices of the same priority linked to said bus, the bus being adapted for the transmission of data to and/or from said peripheral devices and
device of access to the data bus, intended for connection to the principle master peripheral device and to the secondary master peripheral devices, the bus being suitable for data transmission to and/or from said peripheral devices and conveying the frames at MAC layer level, said device of access to the data bus comprising
the means to authorize bus access to the principle master peripheral device when it requests access to the bus, and
the bus access selection means to one of the secondary master peripheral devices when the principal master peripheral device does not request access to the bus.

13. System according to claim 12 comprising at least a slave peripheral device connected to said bus, said slave peripheral device or devices not being able to request access to the bus.

14. System according to claim 13, wherein said peripheral device(s) are memories.

15. System according to claim 12, wherein the said principle master peripheral device comprises a microprocessor.

16. System according to claim 12, wherein it comprises a component that comprises said bus and at least one of said secondary master peripheral devices.

17. System according to claim 16, wherein that said component comprises said principle master peripheral device.
